(19) United States
(12) Patent Application Publication
(10) Pub. No.: US 2026/0307150 A1
(43) Pub. Date: Oct. 8, 2026

(54) METHOD OF LASER-BASED ADDITIVE MANUFACTURING WITH PULSE SCAN PATTERNS FOR MAGNESIUM AND ITS ALLOYS

(71) Applicant: OsseoLabs Co., Ltd., Bangkok (TH)

(72) Inventors: Patcharapit Promoppatum, Nonthaburi (TH); Montian Sukpasert, Nan (TH); Vikram Ahuja, Bangkok (TH); Ola Harrysson, Raleigh, NC (US)

(21) Appl. No.: 19/641,770

(22) Filed: Apr. 8, 2026

Related U.S. Application Data
(60) Provisional application No. 63/785,170, filed on Apr. 8, 2025.

(51) Int. Cl. B22F 10/28; B22F 10/366; B22F 10/85; B33Y 30/00; B33Y 50/02

(52) U.S. Cl. CPC B22F 10/28; B22F 10/366; B22F 10/85; B22F 2301/058; B33Y 30/00; B33Y 50/02

(57) ABSTRACT

This invention introduces an advanced pulse scanning technique for Selective Laser Melting (SLM) of magnesium, addressing critical manufacturing challenges. The method employs iterative optimization to regulate heat input through precise pulse patterns, preventing overheating and material defects. By alternating between powered and unpowered laser phases, the technique reduces material evaporation, minimizes internal stresses, and enhances microstructural uniformity. This approach enables more stable and efficient fabrication of magnesium components for aerospace, biomedical, and industrial applications.

### CROSS-REFERENCE TO RELATED APPLICATION

The present application claims the benefit of U.S. provisional patent application No. 63/785,170. The disclosures of the above-mentioned application are incorporated herein by reference in their entirety.

### FIELD OF THE INVENTION

The present invention relates to a method of laser-based additive manufacturing using pulse scan patterns for magnesium and its alloys.

### BACKGROUND OF THE INVENTION

Additive manufacturing (AM), or 3D printing, has transformed modern manufacturing by enabling the production of complex, high-precision parts directly from digital designs. Selective Laser Melting (SLM) is a leading AM technique that uses a high-powered laser to selectively fuse fine metal powders layer by layer, creating fully dense parts with excellent mechanical properties. The process occurs in a controlled atmosphere, typically using inert gases like argon to prevent oxidation. After each layer is fused, the build platform lowers, and a new layer of powder is applied until the part is complete. Unused powder can be recycled, making SLM highly material-efficient. SLM offers several advantages over traditional manufacturing techniques. It allows for the creation of complex geometries and internal features that are impossible to achieve with conventional methods. It reduces material waste, supports rapid prototyping, and enables the production of customized parts with shorter lead times. Parts produced through SLM exhibit superior mechanical properties, including high strength-to-weight ratios, and often require fewer assemblies, reducing potential failure points

While Selective Laser Melting (SLM) has demonstrated significant advantages in producing high-performance metal components, its application to certain materials presents unique challenges. One such material is magnesium, an ultra-lightweight metal with immense potential across various industries. However, despite its desirable properties, the additive manufacturing of magnesium introduces complexities that require innovative solutions to fully leverage its benefits Background of magnesium

Magnesium is an ultra-lightweight metal with an exceptional strength-to-weight ratio, making it highly valuable in aerospace, automotive, and biomedical applications. Compared to aluminum and steel, magnesium alloys significantly reduce weight while maintaining structural integrity. In the biomedical field, magnesium's biocompatibility and biodegradability make it ideal for implants, such as bone fixation devices, which gradually dissolve in the body, eliminating the need for secondary removal surgeries and reducing long-term complications.

Despite these advantages, additive manufacturing (AM) of magnesium, particularly through traditional SLM techniques, remains challenging due to the metal's unique physical and chemical properties High thermal conductivity and oxygen affinity: Magnesium's strong affinity for oxygen increases the risk of oxidation, requiring stringent environmental controls.
Narrow processing window: With a melting point of ~650° C. and a boiling point of 1,091° C., precise heat control is necessary to avoid defects.
Excessive heat issues: Too much heat can cause rapid evaporation, spattering, and oxidation, degrading surface quality and mechanical properties.

To overcome these challenges, advanced scanning strategies and optimized process parameters are essential. Enhancing heat distribution and minimizing oxidation can improve process stability and part quality. Addressing these issues will unlock the full potential of magnesium in AM, paving the way for high-quality components in industrial, aerospace, and biomedical applications.

### Alternative Approaches for Selective Laser Melting of Highly Reactive Materials

Every existing scanning and environmental control strategy presents unique challenges that affect the quality and stability of magnesium components in SLM. To overcome these limitations, new processing strategies must be developed that effectively balance heat input, minimize oxidation, and enhance process stability. By innovating laser scanning patterns, optimizing energy distribution, and refining environmental controls, it is possible to advance the manufacturability of magnesium in additive manufacturing. These advancements will enable the production of high-quality components for aerospace, biomedical, and industrial applications, fully unlocking the potential of magnesium in next-generation engineering solutions.

### Fabrication Strategies and Challenges:

Continuous Scanning: The laser moves in a single pass over the powder layer, ensuring smooth layer bonding and high efficiency. Challenge: Excessive heat accumulation: Prolonged laser exposure raises local temperature beyond the boiling point, causing vaporization, spattering, and oxidation. Porosity formation: High thermal input increases the risk of keyhole defects and unstable molten pools, degrading part density and mechanical strength.
Multiple Scanning: Involves repeated laser passes over the same region to refine microstructure, reduce porosity, and enhance part density. Challenge: Localized stress buildup: Repeated laser exposure generates excessive thermal accumulation, increasing the likelihood of crack formation and part distortion. Process inefficiency: Additional scanning increases energy consumption and prolongs manufacturing time, reducing overall productivity.
Environmental Control in High-Density Gas Atmospheres: Processing magnesium in an inert environment (high-purity argon or helium) prevents oxidation and combustion, stabilizing the molten pool. Challenge: Residual oxygen contamination: Magnesium's strong oxygen affinity increases the risk of oxidation, necessitating strict environmental controls. Powder bed disturbance from gas flow: Uneven gas distribution can cause powder displacement, leading to defects in layer formation. Imbalanced gas pressure: Excessive gas flow can increase vaporization, while insufficient flow may fail to suppress oxidation effectively.

### Limitations of Prior Art Approaches

While various prior art approaches address melt pool dynamics and energy distribution to reduce porosity, distortion, and process instability, they lack a dedicated framework to safely handle the extreme thermophysical limitations of magnesium.

Several existing methods (such as those disclosed in US20170239752A1) focus on controlling melt pool dynamics by applying pulse or time-varying laser energy input and adjusting parameters-like laser power, exposure time, or scanning strategies—to influence melting characteristics and physical outcomes. However, these approaches primarily rely on real-time control, empirical tuning, or general modeling. They lack a constrained, pre-processing framework that determines parameters prior to fabrication. Although pulse modulation may appear in this prior art, it is not derived through an iterative thermal simulation process to design and refine specific ON/OFF timing and duty cycles. Furthermore, these prior methods are generally material-independent; they do not explicitly enforce a bounded thermodynamic constraint where the melt pool temperature must remain strictly above the melting point but below the boiling point. Without this temperature limit directly guiding parameter selection, existing systems focus mostly on avoiding excessive heat rather than actively enabling stabilized, controlled operation in high-energy regimes, which is critical for highly evaporative metals like magnesium.

Other existing systems (such as those seen in US2022/0388065A1) similarly address melt pool behavior by utilizing modulated, structured, or time-varying laser inputs to avoid undesirable geometries and instability. Yet, this prior art is predominantly focused on geometric shaping and melt pool manipulation-such as forming, reshaping, or redistributing deposited material. It often relies on active manipulation using multiple beams or sequential energy inputs, whereas an industrially applicable single-beam pulse strategy driven by thermal constraints is absent. Additionally, its modulated energy inputs are predefined waveforms rather than optimally determined patterns generated via predictive thermal simulation. Critically, this prior art fails to define a material-dependent thermodynamic constraint (i.e., operating strictly between melting and boiling points) and fails to address the evaporation-driven instabilities native to materials with narrow thermal processing windows.

Furthermore, some recent methods (such as those in WO2024/026100A2) do adopt physics-based thermal modeling as a feedforward control strategy. These methods replace empirical trial-and-error by adjusting parameters (e.g., laser power, dwell time, layer timing) based on predicted thermal responses prior to or during fabrication. However, their predictive models are primarily engineered to mitigate global heat buildup across multiple layers, utilizing inter-layer thresholds (such as differences between layers). They do not establish a phase-based temperature boundary constraint evaluating melting versus boiling thresholds. Consequently, they do not account for materials that suffer from narrow thermodynamic processing windows and boiling-induced instabilities. Importantly, while they use simulation to alter basic power or timing inputs, they do not explicitly couple thermal simulations with the systematic generation of optimized laser pulse patterns (designing precise ON/OFF timings and duty cycles), leaving a significant gap in controlling thermal states for sensitive alloys like magnesium.

### SUMMARY OF THE INVENTION

This invention introduces an iterative optimization strategy for laser-based additive manufacturing in the Selective Laser Melting (SLM) process for magnesium fabrication. While pulse scanning is an integral part of this approach, the primary focus is on iterative refinement of scanning parameters to achieve optimal melting conditions. FIG. 2 illustrates a comparison between continuous scanning and an optimized pulse scanning process, emphasizing the differences in energy input over time and how iterative improvements enhance stability. Unlike conventional continuous scanning, which applies uniform energy, pulse scanning delivers energy in controlled bursts. However, the effectiveness of pulse scanning depends on identifying the optimal ON/OFF duration, exposure time, and scanning speed-all of which are fine-tuned through iterative simulations. This approach prevents overheating, reduces material evaporation, and minimizes internal stresses that commonly occur in traditional scanning methods.

Rather than relying on static pulse parameters, this invention employs an adaptive optimization framework, where an iterative process continuously refines pulse duration, spacing, and power distribution to maximize melt pool stability. This ensures superior microstructural uniformity and reduced defect formation, leading to higher-quality magnesium components.

### BRIEF DESCRIPTION OF THE DRAWINGS

FIG. 1 is a illustrates the selective laser melting (SLM) additive manufacturing process.

FIG. 2 is a Illustrates a comparison of net energy through a graph depicting the relationship between power and exposure time in metal melting.

FIG. 3 is a Schematics of the invention: Illustrated explanation for the definition of pulse pattern.

FIG. 4 is a Flowchart to explain iterative process.

FIG. 5 is a Comparison of pulse patterns and their corresponding simulation results (a-d), along with the temperature profiles for each pulse pattern (e-h).

FIG. 6 is a Cross-sectional comparison of simulated and experimental melt pool geometries under continuous scanning conditions.

FIG. 7 is a Top-view Comparison of pulse scan pattern results between simulation and experiment, illustrating melt track configuration.

FIG. 8 is a Demonstration of the effect of melt pool geometry on additive manufacturing quality, showing correlation between simulated melt pool shape and measured part density.

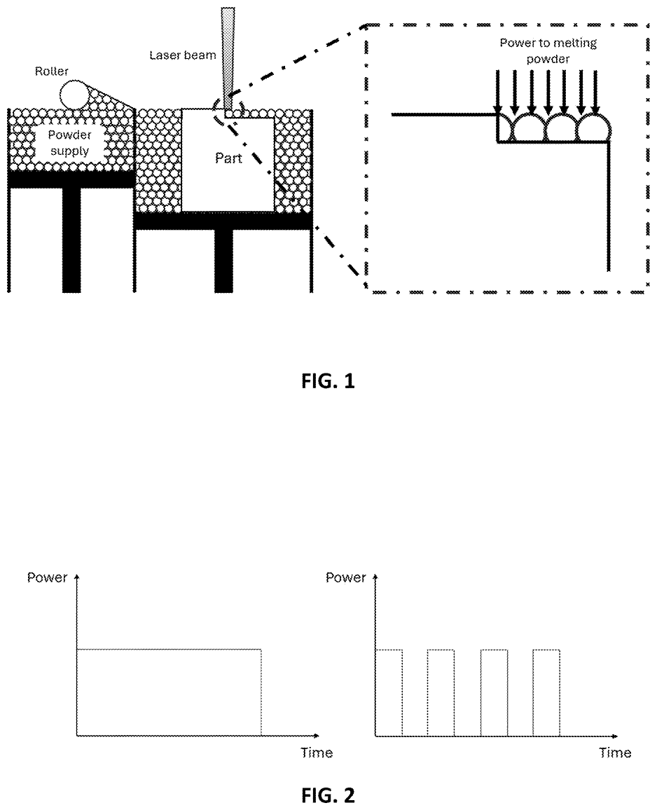

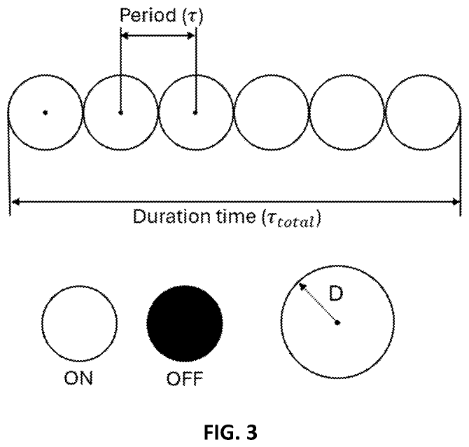

### DETAILED DESCRIPTION OF THE INVENTION

In the following, preferred embodiments of the present invention will be described in detail with reference to the accompanying, exemplary diagrams.

While pulse scanning helps mitigate overheating, the true innovation lies in its iterative optimization. Instead of applying a fixed pulse pattern, this approach continuously refines parameters based on computational feedback. The iterative process determines the most effective pulse exposure time and sequence, ensuring a stable and defect-free melt pool.

### 1. Definition of Key Variables

To establish a standardized understanding of pulse pattern design, essential process variables are defined. The pulse pattern is conceptualized as a series of circular regions with diameters equivalent to the laser beam diameter. The time required to transition between adjacent circles is defined as one period (r) and calculated as the ratio of laser diameter to scanning speed.

The pulse pattern alternates between powered and unpowered phases. White-filled circles denote energized (ON) phases, whereas black-filled circles represent non-energized (OFF) phases. Pulse patterns may be uniform, where ON and OFF durations are equal, or non-uniform, allowing for greater flexibility in energy input regulation. Exposure time serves as the most influential parameter in pulse scanning, determining the duration of the laser's active phase within each period. The duration can be adjusted based on the required energy input to achieve optimal melting, ensuring precise control over the heat distribution.

### 2. Determining the Optimal Pulse Pattern

To refine and optimize the pulse pattern, an iterative computational approach is employed, using Finite Element Analysis (FEA) simulations to model thermal behavior during SLM. This enables precise control over heat distribution and melt pool stability.
Transient thermal simulation: ** The simulation was conducted using Finite Element Analysis (FEA) to model the thermal behavior during the pulse scanning process in Selective Laser Melting (SLM) of magnesium FEA provides a robust numerical framework to solve transient heat transfer problems over complex geometries. To accurately compute the heat distribution within this FEA framework, a mathematically rigorous heat source model must be defined. Initially, the foundational heat transfer can be modeled using Rosenthal's Equation. Rosenthal developed an analytical model to estimate temperature distributions in welded materials by assuming a point beat source and constant thermophysical properties. In this formulation, heat losses due to convection and radiation are ignored, allowing the temperature field to be described analytically, as presented in Eq. (1):

$$T = {T}_{0} + \frac{A P}{2 π rk} exp ( - v \frac{( r + ξ )}{2 α} ) \qquad ( 1 )$$

Although this model performs reasonably well in situations where heat transfer is dominated by conduction, it becomes less accurate under high energy input conditions. In particular, it tends to underestimate melt pool depth because it does not incorporate additional physical effects such as recoil pressure. In Eq. (1), T₀ represents the initial substrate temperature, α denotes thermal diffusivity (m²/s), and k is the thermal conductivity (W/m·K). The variable, ξ, indicates the position along the laser scanning direction, while r=(x²+y²+z²)^{1/2} defines the radial distance from the heat source. Additionally, A is the effective absorptivity, P is the laser power (W), and v is the scan speed (mm/s).

One major limitation of Rosenthal's formulation is its reliance on an idealized moving point heat source, which leads to a mathematical singularity where the predicted temperature becomes infinite at the source location. As a result, it cannot accurately describe temperature behavior in the immediate vicinity of the heat source. Furthermore, it does not account for the finite size of the laser beam.

To address these issues and to simulate the laser's thermal distribution more accurately, the present invention utilizes semi-analytical heat transfer solutions. The heat transfer is based on a conduction mode, replacing the point source with a Gaussian Heat Source Model. The heat source is more realistically represented using a Gaussian distribution, as introduced in Eq. (2):

$$q ( x , y ) = \frac{2 λ P}{π {a}^{2}} exp ( \frac{- 2 {r}^{2}}{{a}^{2}} ) \qquad ( 2 )$$

This modification leads to a revised semi-analytical formulation, as presented in Eq. (3):

$$T = \frac{λ P}{π k} \sqrt{\frac{D}{π}} {\int }_{0}^{∞} \frac{exp [ - \frac{{z}^{2}}{4 Ds} - \frac{{y}^{2} + {( x - s )}^{2}}{( 4 Ds + {a}^{2} )}}{( 4 Ds + {a}^{2} ) \sqrt{s}} ds \qquad ( 3 )$$

For further computational simplification within the simulation model, dimensionless variables and parameters were introduced, as shown in Eq. (4):

$$g = \frac{T}{{T}_{s}} ; {T}_{s} = \frac{λ P}{π ρ {c}_{p} \sqrt{D u {a}^{3}}} \qquad ( 4 )$$

$${x}^{′} = \frac{x}{a} ; {y}^{′} = \frac{y}{a} {z}^{′} = \frac{z}{{( \frac{D a}{u} )}^{0.5}} ; t = \frac{s}{( a / u )}$$

In this framework, the parameter g is defined as the ratio between a specified temperature and the surface temperature. When evaluating melt pool characteristics, the temperature Tis typically taken as the melting point. Spatial coordinates x and y are normalized by the laser radius, while z is scaled using the thermal diffusion depth. The parameter t (or s) represents normalized time, based on how long the laser takes to pass a given point.

Using these normalized variables, Eq. (3) can be reformulated into Eq. (5), which is applied in the present work to computationally estimate the melt pool dimensions:

$$g = {\int }_{0}^{∞} \frac{exp [ - \frac{{z}^{′ 2}}{4 t} - \frac{{y}^{′ 2} + {( {x}^{′} - t )}^{2}}{( 4 p t + 1 )} ]}{( 4 p t + 1 ) \sqrt{t}} d t \qquad ( 5 )$$

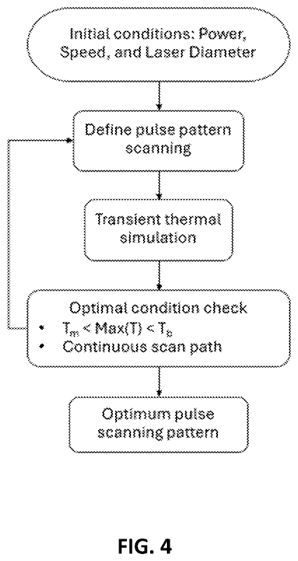

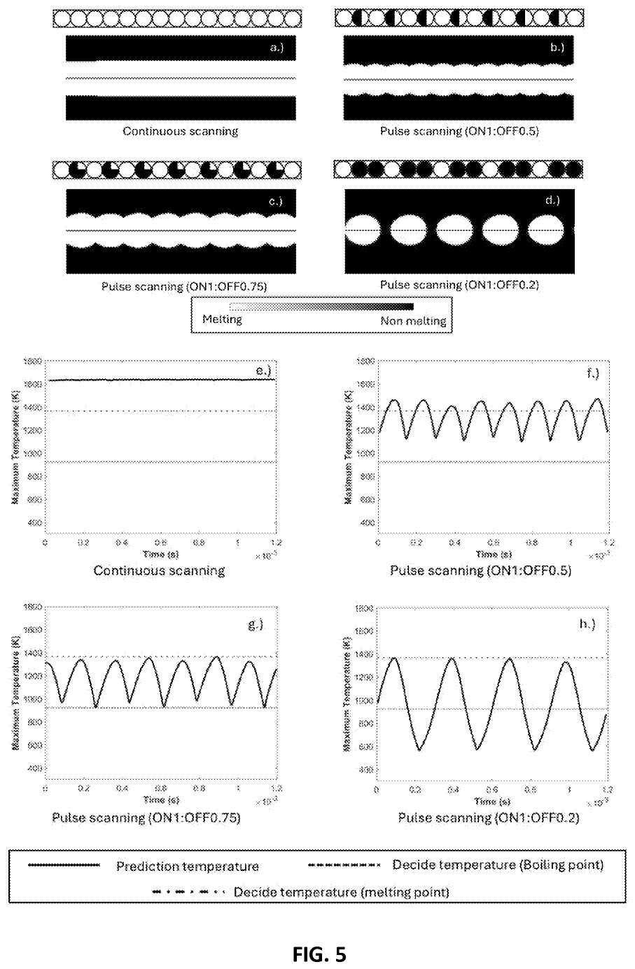

By implementing these semi-analytical heat source solutions, the system can reliably analyze heat distribution throughout the pulse scanning process. Material properties were considered non-temperature dependent, simplifying the FEA simulation by assuming constant thermal conductivity and specific heat capacity throughout the process, ensuring accurate heat distribution during each scan pass. This combined approach provides an efficient and highly accurate way to predict temperature profiles and iteratively optimize SLM parameters for defect-free magnesium fabrication.
Iterative step to finding optimum pulse pattern: To illustrate the process of optimizing the scanning pattern, we first select a power and speed combination that would lead to overheating when using a continuous scanning pattern. Once the target power and speed parameters are established, the next step is to determine the optimal pulse pattern through an iterative process, as outlined in FIG. 4. This process begins with defining an initial pulse pattern, followed by evaluating its effectiveness through simulation. A computational model based on the Gaussian heat distribution equation is developed to simulate transient thermal behavior. The simulation generates temperature fields at each time step, allowing for an analysis of heat distribution throughout the scanning process.

The resulting temperature profiles are then analyzed to verify whether the material remains within the desired melting and boiling point ranges. Additionally, the scan path characteristics are assessed for continuity and completeness to ensure process stability. This iterative approach enables the identification of a pulse pattern that mitigates excessive heat buildup and maintains consistent melting conditions, thereby improving the reliability of the fabrication process.

### Benefit of Pulse Scan Pattern

1. Reduction of Over-Melting Defects: Pulse scanning reduces excessive heat input by alternating between melting and cooling phases. This prevents overheating, which often leads to metal evaporation and structural defects. By lowering total energy while maintaining sufficient density for melting, pulse scanning ensures a more stable process, minimizing defects in materials with low boiling points.

2. Minimization of Powder Loss from Evaporation: By keeping the melting temperature below the boiling point, pulse scanning reduces material loss caused by excessive evaporation. Unlike continuous scanning, which can overheat and vaporize metal powder, pulse scanning preserves more material, improving efficiency and reducing costs in 3D printing while maintaining high-quality fusion.

3. Improved Temperature Gradient Control: Pulse scanning moderate thermal fluctuations by introducing controlled cooling phases. This reduces steep temperature gradients, minimizing residual stresses and distortions in printed parts. By allowing gradual heat dissipation, pulse scanning enhances structural stability, improving dimensional accuracy and reducing the likelihood of warping or cracking in additively manufactured components.

4. Enhancement of Mechanical Properties: Controlled cooling in pulse scanning refines the microstructure, reducing excessive grain growth. This results in finer, more uniform grains, improving mechanical properties such as tensile strength and fatigue resistance. The improved metallurgical structure enhances the durability and reliability of printed parts, making them stronger and less prone to failure

### Technical Uniqueness of the Present Invention

This invention is unique because it introduces a fundamentally different approach to parameter optimization for Selective Laser Melting (SLM) of magnesium alloys. Most prior studies adjust power, speed, or hatch spacing while keeping the laser continuous, which is unsuitable for magnesium's extremely narrow thermal window and susceptibility to boiling and oxidation. Even when pulse scanning has been mentioned in the literature, it is typically implemented with fixed duty cycles and without a systematic way to determine whether the pulse pattern maintains temperatures within safe limits. The present method departs from these practices by using iterative, simulation-driven pulse pattern optimization. Instead of relying on time-consuming trial-and-error experiments, it couples transient thermal simulation with a clear temperature criterion, in which the melt pool must remain above the melting point and below the boiling point of magnesium. This establishes a deterministic path to identifying a viable pulse ratio rather than experimenting blindly. This approach is especially significant for magnesium, where minor changes in heat input can quickly cause evaporation, spattering, or melt-track instability. By using simulation as the decision framework, the invention makes it possible to safely apply higher laser powers that would fail under continuous scanning. Although hardware and software tools may be publicly available, the ability to construct, calibrate, and apply this optimization loop depends on specialized insight, proprietary data, and extensive validation. This knowledge cannot be easily transferred or replicated simply by using similar equipment.

In summary, the invention is unique because it:
Replaces continuous scanning with a systematically optimized pulse regime,
Uses iterative thermal simulation to identify safe and effective pulse patterns,
Applies a quantifiable temperature constraint absent in prior art, and
Avoids the traditional, slow, experimental search for parameters.
   These elements collectively create a novel and effective method for SLM of magnesium that existing approaches do not provide.

### Demonstrate Example Invention

To validate the proposed pulse scanning technique, we applied it in an SLM environment using magnesium powder. In the research of Liu et al (Liu, Jinge, et al. “Biodegradable magnesium alloy WE43 porous scaffolds fabricated by laser powder bed fusion for orthopedic applications: Process optimization, in vitro and in vivo investigation.” Bioactive Materials 16 (2022): 301-319.), it was found that the optimal continuous scanning parameters were 60 W and 600 mm/s. To highlight the benefits of pulse scanning, we intentionally selected overheating-prone conditions of 70 W at 600 mm/s and tested three pattern of pulse ratios including 1ON:0.50FF (equal melting and cooling), 1ON:0.750FF (extended cooling), and 1ON:10FF (significantly prolonged cooling). Evaluation focused on maximum temperature control and melt track continuity. The 1ON:0.50FF pattern produced a continuous melt track but exceeded magnesium's boiling point, risking evaporation and porosity. The 1ON:2OFF pattern resulted in insufficient heat input, causing discontinuous melting. In contrast, the 1ON:0.750FF pattern maintained a stable melt track while keeping temperatures within the optimal range, minimizing defects like porosity and incomplete fusion. By balancing heat input and cooling, the 1ON:0.750FF pattern ensures structural integrity and process stability, demonstrating pulse scanning's advantages over conventional continuous scanning in SLM.

### Melt Pool Dimension Validation Under Continuous Scanning

To verify the accuracy of the transient thermal simulation model developed for predicting melt-pool behavior, a validation study was performed comparing simulation results with experimental data under continuous scanning conditions. This stage was conducted to confirm that the computational model accurately represents the thermal behavior of magnesium melting without the influence of pulse-dependent variables. Continuous scanning was intentionally selected for model validation to eliminate the location-dependent variation inherent in pulse scan patterns. In both simulation and experiment, identical laser parameters were applied, including laser power, scanning speed, and beam diameter. The purpose of maintaining these identical parameters was to ensure that any observed differences in melt-pool dimension were solely due to model performance rather than parameter variation. After processing, cross-sectional samples were analyzed to measure both the melt-pool width and depth.

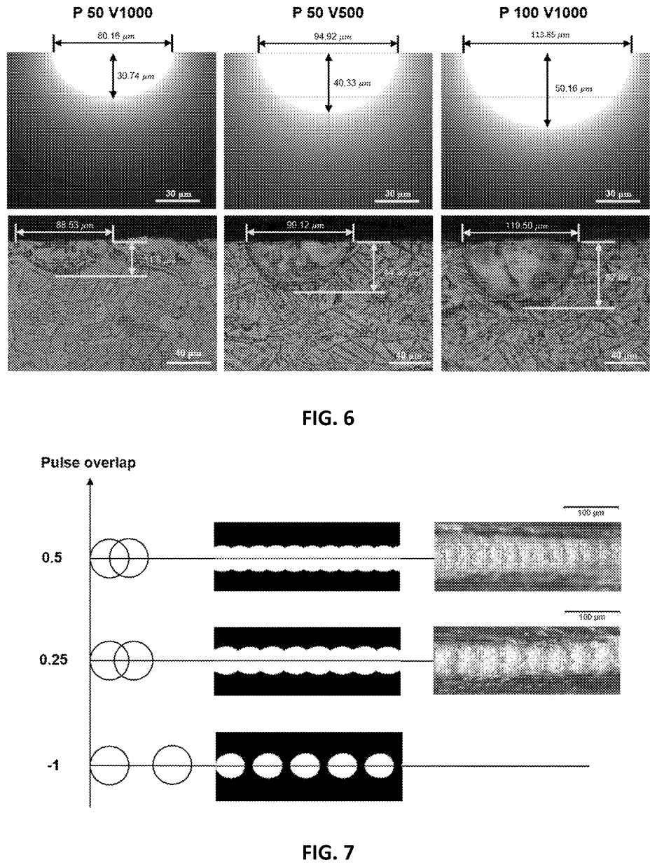

As illustrated in FIG. 6, the predicted melt-pool geometry from the simulation closely corresponds to the experimentally observed cross-section. Both the melt-pool depth and width show consistent alignment between prediction and measurement. This agreement confirms that the thermal model accurately predicts melt-pool dimensions and temperature distributions under continuous scanning conditions. Consequently, the model is validated for use in subsequent analysis of pulse scan patterns and can be reliably employed to study heat-transfer behavior during the Selective Laser Melting (SLM) process of magnesium and its alloys.

### Demonstration of the Pulse Scan Pattern

To demonstrate the validity of the pulse scan pattern concept, both simulation and experimental evaluations were performed under comparable conditions. Although a fully equipped additive manufacturing system with pulse laser capability was not available, a laser polishing machine was modified to generate a controlled pulse energy sequence that reproduces the pulse scan pattern behavior. The experimental setup was designed to match the parameters used in the simulation of the invention demonstration, including laser power, scanning speed, beam diameter, and defined ON/OFF durations. The comparison between simulation and experimental conditions is summarized in tale below, where several pulse ratios were investigated-namely 1 ON: 0.5 OFF, 1 ON: 0.75 OFF, and 1 ON: 2 OFF.

The comparison shown in FIG. 7 presents the top-view observation of melt tracks produced by both simulation and experiment. When evaluated under identical pulse-shot ratios, both the track configuration and track width exhibit similar characteristics. These results indicate that the simulation of pulse scan pattern behavior accurately represents the physical response observed in the experiment. Therefore, the validated model can be effectively used to predict the melting behavior of pulse scanning in practical laser-based additive manufacturing. This finding supports the reliability of the proposed method for determining the optimal pulse scan pattern in the SLM process.

| Simulation | Experiment |
|---|---|
| Laser diameter (μm) | 60 |
| Power (W) | 70 |
| Pulse overlap | 0.5 (ON 1, OFF0.5) |
| | 0.25 (ON1, OFF0.75) |
| | −1 (ON1, OFF2) |

### Demonstration of Melt Pool Geometry Effect on Additive Manufacturing

To further illustrate the influence of melt-pool geometry on the quality of fabricated parts, a demonstration was performed using continuous scanning conditions in both simulation and fabrication. This evaluation was aimed at understanding how variations in melt-pool dimensions obtained from the prediction model affect the actual part fabrication and resulting relative density of additively manufactured magnesium components.

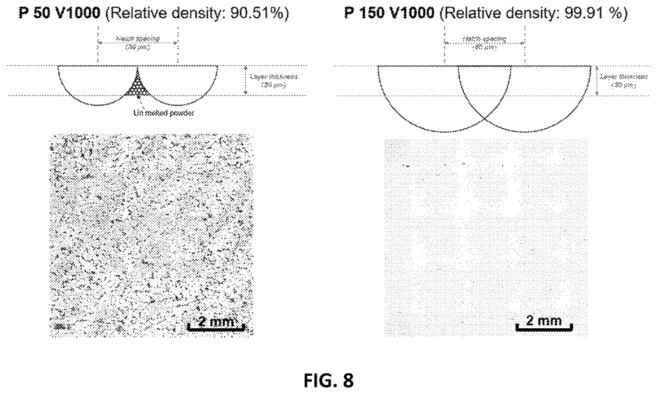

As shown in FIG. 8, the lower image presents the relative-density distribution of fabricated magnesium parts produced under the same parameters used in the simulation, including laser power, scanning speed, hatch spacing, and layer thickness. The upper schematic illustrates the simulated melt-pool geometry, indicating the powder-layer thickness (30 μm) and hatch spacing (80 μm) applied in the fabrication experiment. When comparing two representative cases—50 W/1000 mm s⁻¹ and 150 W/1000 mm s⁻¹—distinct differences are observed. In the lower-power case, the melt-pool depth is insufficient to overlap the subsequent powder layer, leaving regions of un-melted powder that correspond to low relative density in the fabricated sample. Conversely, at higher power, the melt pool fully penetrates the powder layer and overlaps adjacent tracks, resulting in a dense and continuous structure.

Although this section utilizes continuous scanning rather than pulse scanning, the consistency between the simulation and experimental outcomes demonstrates that the validated model can predict melt-pool geometry and its impact on fabrication quality. Accordingly, this validated simulation model provides a strong foundation for evaluating and optimizing pulse scan-pattern parameters in future additive manufacturing processes involving magnesium and its alloys.

1. A method of additive manufacturing a magnesium or magnesium alloy object using a Selective Laser Melting (SLM) system, the method comprising: providing initial parameters including laser power and scanning speed for a magnesium or magnesium alloy powder; generating an initial pulse scan pattern comprising alternating ON and OFF durations; and controlling a laser source of the SLM system to irradiate a powder bed of the magnesium or magnesium alloy powder according to a pulse scan pattern to physically fabricate the object, wherein the improvement comprises:
executing a computational thermal simulation based on a physics-based heat transfer model by a computer processor to predict a maximum melt pool temperature based on the initial pulse scan pattern; and iteratively adjusting the ON and OFF durations of the pulse scan pattern by the computer processor until the predicted maximum melt pool temperature satisfies the condition: Tₘ<Max(T)<T_{b}, wherein Tₘ is the melting point and T_{b} is the boiling point of the magnesium or magnesium alloy, prior to controlling the laser source to irradiate the powder bed according to the adjusted pulse scan pattern.

2. The method of claim 1, wherein the computational thermal simulation comprises a transient thermal simulation using Finite Element Analysis (FEA) with a Gaussian heat source model.

3. The method of claim 1, wherein the computational thermal simulation utilizes a Rosenthal's Equation for laser processing.

4. The method of claim 1, wherein the computational thermal simulation utilizes a semi-analytical heat transfer solution.

5. The method of claim 1, wherein a period (r) of the pulse scan pattern is calculated as a ratio of a laser beam diameter to the scanning speed.

6. The method of claim 1, wherein the provided initial laser power is higher than an optimal power used in a continuous scan mode for the same magnesium or magnesium alloy.

7. An additive manufacturing system for fabricating a magnesium or magnesium alloy object, comprising: a build platform containing a magnesium or magnesium alloy powder bed; a laser source configured to emit a pulse-modulated laser beam; and a controller operatively coupled to the laser source, wherein the controller is programmed to execute a computational thermal simulation based on a physics-based heat transfer model to predict a maximum melt pool temperature, iteratively adjust ON and OFF durations of the pulse-modulated laser beam such that the predicted maximum melt pool temperature is maintained above the melting point (Tₘ) and below the boiling point (T_{b}) of the magnesium or magnesium alloy powder, and direct the laser source to fuse the powder based on the adjusted ON and OFF durations to physically fabricate the object.

8. The system of claim 7, wherein the computational thermal simulation executed by the controller comprises a Finite Element Analysis (FEA), a Rosenthal's Equation, or a semi-analytical heat transfer solution.
